(19) United States
(12) Patent Application Publication
(10) Pub. No.: US 2014/0020214 A1
(43) Pub. Date: Jan. 23, 2014

(54) Magnetic Clasp

(71) Applicants: Garabed Ayvazian, East Hampton, NY (US); Barry Smith, Weston, CT (US); Carl Morfino, Colts Neck, NJ (US); Edward Yosevitz, Staten Island, NY (US)

(72) Inventors: Garabed Ayvazian, East Hampton, NY (US); Barry Smith, Weston, CT (US); Carl Morfino, Colts Neck, NJ (US); Edward Yosevitz, Staten Island, NY (US)

(73) Assignee: Quality Casting, Inc., Long Island City, NY (US)

(21) Appl. No.: 13/610,571

(22) Filed: Sep. 11, 2012

Related U.S. Application Data
(60) Provisional application No. 61/672,972, filed on Jul. 18, 2012.

(51) Int. Cl. A44B 99/00; B23P 11/00; H01F 7/02

(52) U.S. Cl. 24/303; 29/428

(57) ABSTRACT

Clasps and methods of manufacturing the clasps are disclosed. The clasp comprises a male end, a female end coupleable to the male end. The female end comprises at least two pushers, the pushers each movable between a first position and a second position, and at least one magnet coupled to each pusher. The pushers are positioned such that when the pushers are each in the first position, the magnetic force between the magnets biases the pushers toward the second position.

### REFERENCE TO RELATED APPLICATIONS

This application claims priority to U.S. Provisional Application No. 61/672972, filed Jul. 18, 2012, which is entitled “Magnetic Clasp,” and is hereby specifically and entirely incorporated by reference.

### BACKGROUND

1. Field of the Invention

The invention is directed to clasps and, in particular, the invention is directed to magnetic clasps for jewelry.

2. Background of the Invention

Jewelry such as necklaces and bracelets that have a clasp for connecting the jewelry around the body are well known in the art. Although a wide variety of jewelry clasps are available, the most common types of clasps are bayonet clasps, lobster clasps, spring ring clasps, and conventional hook-type clasps.

Bayonet clasps include a female end affixed to one end of the open necklace or bracelet. The female end includes a slot that is adapted to receive the male end of the bayonet clasp attached to the other end of the open necklace or bracelet. The male end of the bayonet clasp includes a spring-biased member for engaging the female end. The female end has anchoring portions and, as the male end is inserted into the female end, the spring-biased member of the male end engages the anchoring portion of the female end. This arrangement secures the male end within the female end. The anchoring portions interact with blocking portions to prevent inadvertent release of the male end from the female end. The male end is released by depressing a pusher on the male end to provide clearance of the anchoring portions of the female end and to allow the male end to be withdrawn from the female end.

Lobster clasps have a ring affixed to one end of the opened necklace or bracelet and a closed hook resembling a lobster-claw affixed to the other end of the open necklace or bracelet adapted to hook onto the ring. The lobster-claw has a fixed portion and a movable portion. The movable portion is coupled to the fixed portion and can swivel between an open position and a closed position. By pressing a tab of the movable portion, the lobster-claw opens, allowing the ring to be inserted into or removed from the fixed portion. The movable portion of the lobster-claw is spring biased toward the closed position so that the ring cannot be inadvertently released from the lobster-claw during normal use. Spring ring clasps operate similarly, except that the spring biased end can be retracted from a hollow portion of a C-shaped housing that supports the spring biased end. The closed spring ring clasp is used to retain a ring located on the opposite end of the necklace or bracelet.

Hook-type clasps generally include an eyelet attached to one end of the open necklace or bracelet and a hook attached to the other end of the necklace or bracelet. Operation of these types of clasps simply involves placing the hook through the eyelet. The weight of the necklace or bracelet around the neck or wrist of the wearer tends to keep the hook attached to the eyelet.

While the above described devices provide methods of connecting the ends of the necklace or bracelet, there is need for a sturdier, wear-resistant, and simpler mechanism for accomplishing this task. Because of the necessarily small size of the components required for connecting the necklace or bracelet ends, many clasps become bent, deformed, or broken through frequent use. Furthermore, in clasps that employ springs, the springs can become worn out, fatigued, or broken. Constructing clasps having stronger components typically requires added size and weight to the clasp in addition to detracting from its aesthetic appearance. Additionally, because it is known that each of the above mentioned clasps is likely to break, manufactures of the claps often install extra safety mechanisms to prevent the necklace or bracelet from falling off.

### SUMMARY OF THE INVENTION

The present invention overcomes the problems and disadvantages associated with current strategies and designs and provides new tools and methods of coupling two portions of a piece of jewelry.

One embodiment of the invention is directed to a clasp system. The system comprises a male end and a female end coupleable to the male end. The female end comprises at least two pushers, the pushers each movable between a first position and a second position, and at least one magnet coupled to each pusher. The pushers are positioned such that when the pushers are each in the first position, the magnetic force between the magnets biases the pushers toward the second position.

In the preferred embodiment, the first and second magnets are positioned to be magnetically attracted to each other. Preferably, the system further comprises a first peg coupled to a first pusher and a second peg coupled to a second pusher, wherein the first and second pegs are adapted to engage the male portion. The second peg preferably extends from the second pusher and through the first pusher.

Preferably, the male portion comprises at least two recesses adapted to mate with the first and second pegs. Preferably, at least one magnet is a permanent magnet. In the preferred embodiment, the female portion further comprises an outer housing having two sections at least one of crimped or welded together.

Preferably, a force applied to a pusher moves the pusher from the second position to the first position. In the second position of both pushers, preferably the male portion is able to be secured within the female portion and, in the first position of both pushers, the male portion is able to enter and be removed from the female portion. In the preferred embodiment, neither the female portion nor the male portion have springs.

Another embodiment of the invention is directed to a female portion of a clasp. The female portion of the clasp comprises at least two pushers, the pushers each movable between a first position and a second position, and at least one magnet coupled to each pusher. The pushers are positioned such that when the pushers are each in the first position, the magnetic force between the magnets biases the pushers toward the second position.

Preferably, the first and second magnets are positioned to be magnetically attracted to each other. Preferably, the female portion further comprises a first peg coupled to a first pusher and a second peg coupled to a second pusher, wherein the first and second pegs are adapted to engage a male portion.

In a preferred embodiment, the second peg extends from the second pusher and through the first pusher. Preferably, the male portion comprises at least two recesses adapted to mate with the first and second pegs. In the preferred embodiment, at least one magnet is a permanent magnet.

Preferably, the female portion further comprises an outer housing having two sections at least one of crimped or welded together. A force applied to a pusher preferably moves the pusher from the second position to the first position. In the preferred embodiment, in the second position of both pushers, a male portion is able to be secured within the female portion and, in the first position of both pushers, the male portion is able to enter and be removed from the female portion. Preferably, neither the female portion nor the male portion have springs.

Another embodiment of the invention is directed to a method of assembling a female clasp portion. The method comprises the steps of positioning a first pusher into a bottom half of an outer housing of the female clasp portion, coupling a first magnet to the first pusher, positioning a second pusher adjacent to the first pusher, coupling a second magnet to the second pusher, wherein the first magnet and the second magnet are magnetically attracted to each other, and coupling a top half of the outer housing to the bottom half of the outer housing.

Preferably, the top half of the outer housing is at least one of welded or crimped to the bottom half of the outer housing. The method preferably further comprises positioning a peg coupled to the first pusher through a hole in the second pusher. In the preferred embodiment, the first pusher and the second pusher are each adapted to be pushed towards the center of the outer housing. Preferably, when both the first pusher and the second pusher are pushed toward the center of the outer housing a male portion is able to enter and be removed from the female portion and when both the first pusher and the second pusher are released the male portion is able to be secured within the female portion.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 depicts an embodiment of a clasp of the invention.

FIG. 2 depicts an exploded view of an embodiment of the clasp of the invention.

FIG. 3 depicts a partially assembled view of an embodiment of the invention.

FIG. 4 depicts another partially assembled view of an embodiment of the invention.

FIG. 5 depicts an embodiment of components of the invention in a locked position.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

A problem in the art capable of being solved by the embodiments of the present invention is creating an easy to use clasp that does not wear out or inadvertently open. It has been surprisingly discovered that, employing the attractive forces of magnets, a tongue coupled to one end of a piece of jewelry can be secured into a body coupled to the opposite end of the piece of jewelry to prevents loss of the piece of jewelry due to the clasp accidently opening.

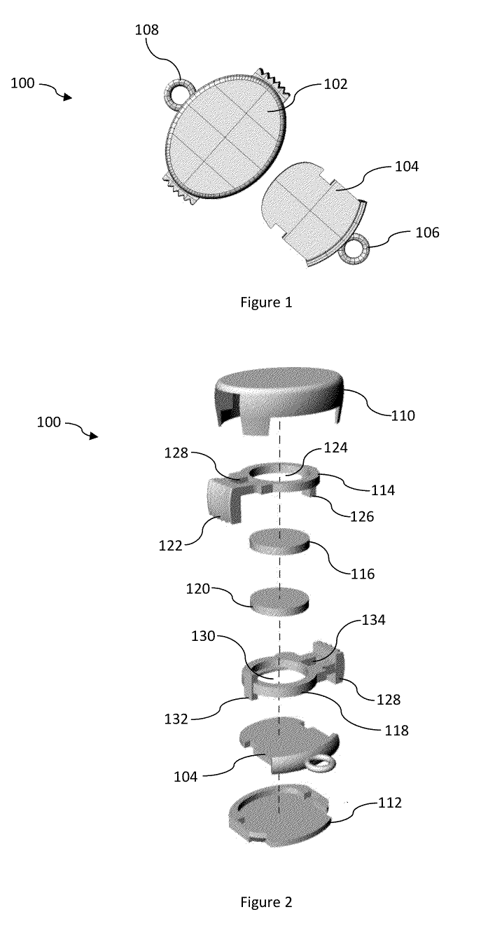

FIG. 1 depicts an embodiment of a clasp 100. Clasp 100 is comprised of a female end 102 and a male end 104. In the preferred embodiment, clasp 100 is used to couple two ends of a piece of jewelry. For example female end 102 can be coupled to one end or portion of a bracelet, a necklace, a watch, a string of pearls, a broach, a pin, an earring, a cufflink, a chain, a pendent, or another finding, while male end 104 is coupled to the other end or another portion of the piece of jewelry. In the preferred embodiment, male end 104 and female end 102 may have attachment rings 106 and 108, respectively, for coupling the jewelry to either end of clasp 100. However, the jewelry can be coupled to clasp 100 by welding, adhesive, friction, screws, bolts, brads, toggles, or other fastening devices. Furthermore, the ends of clasp 100 can be integral to the jewelry.

Preferably, clasp 100 is made of non-magnetic metal, for example gold, silver, copper, bronze, stainless steel, titanium, or platinum. However, clasp 100 can be made of plastic, rubber, wood, nylon, or other naturally occurring or man-made materials. In the preferred embodiment, both female end 102 and male end 104 are made of the same material, however each end can be made of a different material. In the preferred embodiment, female end 102 has at least one surface that can be engraved (e.g. with a company logo, initials, or a name), set with a stone, or otherwise adorned.

FIG. 2 is an exploded view of clasp 100, including both male end 104 and the components of female end 102. The components of female end 102 are housed between cover 110 and bottom plate 112. When coupled, cover 110 and bottom plate 112 define an outer housing. Cover 110 and bottom plate 112 enclose first pusher 114, first magnet 116, second pusher 118, and second magnet 120. When assembled, first pusher 114 and second pusher 118 preferably extend outside of cover 110 through a gap therein (as shown in FIG. 1). Preferably first pusher 114 and second pusher 118 extend out of opposite sides of cover 110, however first pusher 114 and second pusher 118 can extend out of cover 110 perpendicularly to each other or at another angle from each other. First pusher 114 and second pusher 118 may also be referred to as plungers, tabs, cams, or toggles.

First pusher 114 preferably comprises a finger pad 122, a magnet holder 124, a peg 126, and a peg recess 128. Finger pad 122 can have a friction increasing surface (e.g. serrations, a rough surface, rubber, or another material). Preferably, finger pad 122 extends perpendicularly from the body of first pusher 114 in a single direction. However, finger pad 122 can extend in another direction, at an angle, or in multiple directions. Magnet holder 124 is preferably adapted to receive magnet 116. Preferably magnet holder 124 has an inner diameter approximately equal to the outer diameter of magnet 116 to prevent magnet 116 from moving within pusher 114 during use. However, magnet holder 124 can be another device capable of securing magnet 116 (e.g. adhesive, screws, welds, bolts, or other fasteners). Preferably, peg 126 extends perpendicularly from the body of first pusher 114 in a single direction. Preferably peg 126 extends in the same direction as finger pad 122. However, peg 126 can extend in another direction, at an angle, or in multiple directions. Preferably, peg recess 128 is a hole or recess within the body of first pusher 114 that is adapted to receive a peg coupled to second pusher 118.

Second pusher 118 preferably comprises a finger pad 128, a magnet holder 130, a peg 132, and a peg recess 134. Finger pad 128 can have a friction increasing surface (e.g. serrations, a rough surface, rubber, or another material). Preferably, finger pad 128 extends perpendicularly from the body of second pusher 118 in two directions. However, finger pad 128 can extend in one direction, at an angle, or in multiple directions. Magnet holder 130 is preferably adapted to receive magnet 120. Preferably magnet holder 130 has an inner diameter approximately equal to the outer diameter of magnet 120 to prevent magnet 120 from moving within pusher 118 during use. However, magnet holder 130 can be another device capable of securing magnet 120 (e.g. adhesive, screws, welds, bolts, or other fasteners). Preferably, peg 132 extends perpendicularly from the body of second pusher 118 in two directions. Preferably peg 132 extends in the same directions as finger pad 128. However, peg 132 can extend in other directions, at an angle, or in a single direction. Preferably, at least a portion of peg 132 is adapted to extend through peg recess 128 of first pusher 114. In the preferred embodiment, peg recess 134 is a hole or recess within the body of second pusher 118 that is adapted to receive peg 126 of first pusher 114.

Magnet 116 is preferably identical to magnet 120. Magnets 116 and 120 are preferably both permanent magnets. However, one of magnet 116 and 120 can be a permanent magnet and the other can be another magnetic material. For example, magnets 116 and 120 can be made from magnetized iron, cobalt, nickel, ceramic, a rare earth metal, or another magnetic material. While two magnets are shown, another number of magnets can be used. For example there can be 3, 4, or 5 magnets. In the preferred embodiment magnet 116 and magnet 120 are positioned within clasp 100 so that magnet 116 and magnet 120 are attracted to each other (i.e. have opposite poles facing each other). However, in certain embodiments, magnets 116 and 120 can be positioned to repel each other (i.e. have like poles facing each other).

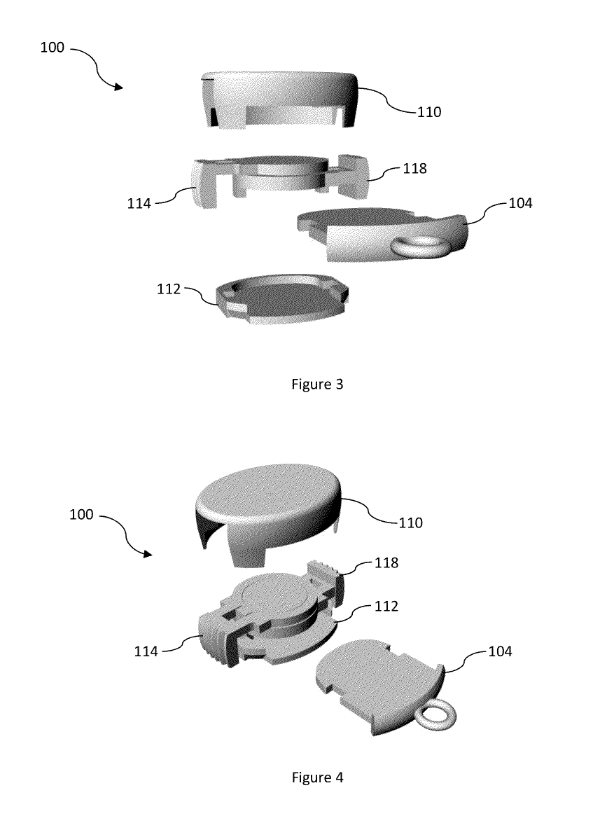

FIG. 3 depicts a partially assembled embodiment of clasp 100. As can be seen in FIG. 3, pusher 114 with magnet 116 coupled thereto is interconnected with pusher 118 with magnet 120 coupled thereto. Pusher 114 and pusher 118 are able to slide relative to each other. In the preferred embodiment, pusher 114 and pusher 118 are furthest apart when magnet 116 is magnetically aligned with magnet 120. Magnet 116 is preferably magnetically aligned with magnet 120 when the center of magnet 116 is aligned with the center of magnet 120. Additionally, magnet 116 is preferably magnetically aligned with magnet 120 when the magnets are positioned relative to each other so that the magnetic forces between the magnets cannot pull the magnets any closer together. Preferably, pusher 114 and pusher 118 are able to slide toward each other to bring magnets 116 and 120 out of alignment. When magnets 116 and 120 are out of alignment the magnetic attraction between the magnets forces pushers 114 and 118 toward each other when pushers 114 and 118 are released.

FIG. 4 depicts another partially assembled embodiment of clasp 100. When fully assembled, female end 102 provides an opening between pusher 118 and bottom plate 112. The opening is adapted to receive male end 104. Preferably, cover 110 is crimped onto bottom plate 112. However cover 110 can be coupled to bottom plate 112 with adhesives, soldering, screwed together, friction, welds, set screws, or other fasteners. Preferably, when assembled, pushers 118 and 114 are only able to slide toward each other; pushers 118 and 114 are not able to separate.

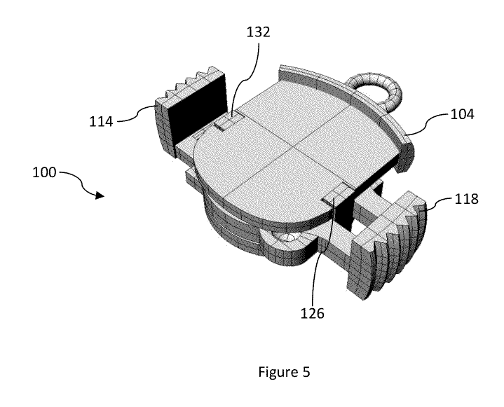

FIG. 5 depicts a bottom view of male end 104 inserted into the opening of female end 102. By inserting male end 104 into female end 102, the leading edge of male end 104 preferably forces peg 126 extending from pusher 114 and peg 132 extending from pusher 118 away from each other (thereby forcing pusher 114 and pusher 118 toward each other). As male end 104 further engages female end 102, pegs 126 and 132 preferably align and engage with recesses in male end 104. FIG. 5 depicts clasp 100 in the locked position. In the locked position, peg 126 extending from pusher 114 and peg 132 extending from pusher 118 preferably each engage a recess in male end 104. Therefore, in the embodiment depicted, pegs 126 and 132 are the actual locking mechanism, securing male end 104 into female end 102. Once engaged, pegs 126 and 132 prevent male end 104 from inadvertently coming out of female end 102. The magnetic forces between magnets 116 and 120 preferably force pegs 126 and 132 into the recesses in male end 104, which can only be released by sliding pushers 118 and 114 toward each other. Magnets 116 and 120 preferably do not act as the locking mechanism. Instead, magnets 116 and 120 preferably provide the force necessary to maintain pegs 126 and 132 in a locked position. Preferably, both pushers 118 and 114 must be pushed toward each other to unlock clasp 100 (i.e. pushing just one of pusher 118 or pusher 114 will not unlock clasp 100).

Preferably, the force provided by the magnetic properties of clasp 100 negate the need for additional safety mechanisms. Furthermore, since there are no springs, gears, strike plates, hardened gold, or other parts that are likely to wear out, clasp 100 preferably does not need to be adjusted or refurbished. In the preferred embodiment, at least one component on the interior of female end 104 may have a heat indicating device. For example, a component can be coated with a heat sensitive paint or dye that changes properties when exposed to heat.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A clasp system, comprising:
a male end;
a female end coupleable to the male end, the female end comprising:
at least two pushers, the pushers each movable between a first position and a second position; and
at least one magnet coupled to each pusher;
wherein, the pushers are positioned such that when the pushers are each in the first position, the magnetic force between the magnets biases the pushers toward the second position.

2. The clasp system of claim 1, wherein the first and second magnets are positioned to be magnetically attracted to each other.

3. The clasp system of claim 1, further comprising a first peg coupled to a first pusher and a second peg coupled to a second pusher, wherein the first and second pegs are adapted to engage the male portion.

4. The clasp system of claim 3, wherein the second peg extends from the second pusher and through the first pusher.

5. The clasp system of claim 3, wherein the male portion comprises at least two recesses adapted to mate with the first and second pegs.

6. The clasp system of claim 1, wherein at least one magnet is a permanent magnet.

7. The clasp system of claim 1, wherein the female portion further comprises an outer housing having two sections at least one of crimped or welded together.

8. The clasp system of claim 1, wherein a force applied to a pusher moves the pusher from the second position to the first position.

9. The clasp system of claim 1, wherein, in the second position of both pushers, the male portion is able to be secured within the female portion and, in the first position of both pushers, the male portion is able to enter and be removed from the female portion.

10. The clasp system of claim 1, wherein neither the female portion nor the male portion contain a spring.

11. A female portion of a clasp, comprising:
at least two pushers, the pushers each movable between a first position and a second position; and
at least one magnet coupled to each pusher;
wherein, the pushers are positioned such that when the pushers are each in the first position, the magnetic force between the magnets biases the pushers toward the second position.

12. The female portion of claim 11, wherein the first and second magnets are positioned to be magnetically attracted to each other.

13. The female portion of claim 11, further comprising a first peg coupled to a first pusher and a second peg coupled to a second pusher, wherein the first and second pegs are adapted to engage a male portion.

14. The female portion of claim 13, wherein the second peg extends from the second pusher and through the first pusher.

15. The female portion of claim 13, wherein the male portion comprises at least two recesses adapted to mate with the first and second pegs.

16. The female portion of claim 11, wherein at least one magnet is a permanent magnet.

17. The female portion of claim 11, further comprising an outer housing having two sections at least one of crimped or welded together.

18. The female portion of claim 11, wherein a force applied to a pusher moves the pusher from the second position to the first position.

19. The female portion of claim 11, wherein, in the second position of both pushers, a male portion is able to be secured within the female portion and, in the first position of both pushers, the male portion is able to enter and be removed from the female portion.

20. The female portion of claim 11, wherein neither the female portion nor the male portion contain a spring.

21. A method of assembling a female clasp portion, comprising the steps of:
positioning a first pusher into a bottom half of an outer housing of the female clasp portion;
coupling a first magnet to the first pusher;
positioning a second pusher adjacent to the first pusher;
coupling a second magnet to the second pusher, wherein the first magnet and the second magnet are magnetically attracted to each other; and
coupling a top half of the outer housing to the bottom half of the outer housing.

22. The method of claim 20, wherein the top half of the outer housing is at least one of welded or crimped to the bottom half of the outer housing.

23. The method of claim 20, further comprising positioning a peg coupled to the first pusher through a hole in the second pusher.

24. The method of claim 20, wherein the first pusher and the second pusher are each adapted to be pushed towards the center of the outer housing.

25. The method of claim 24, wherein when both the first pusher and the second pusher are pushed toward the center of the outer housing a male portion is able to enter and be removed from the female portion and when both the first pusher and the second pusher are released the male portion is able to be secured within the female portion.
